(19) United States
(12) Patent Application Publication
(10) Pub. No.: US 2009/0190125 A1
(43) Pub. Date: Jul. 30, 2009

(54) Device and Method for Spectrometric System

(76) Inventors: Stephen Foster, Macclesfield Cheshire (GB); Karl Freedman, Macclesfield Cheshire (GB)

Correspondence Address: WHITE & CASE LLP;PATENT DEPARTMENT, 1155 AVENUE OF THE AMERICAS, NEW YORK, NY, 10036, US

(21) Appl. No.: 12/278,326

(22) PCT Filed: Feb. 6, 2007
(86) PCT No.: PCT/SE07/00109

§ 371 Date: Aug. 5, 2008

(30) Foreign Application Priority Data
Feb. 7, 2006 (SE) 0600271-1

(51) Int. Cl. G01J 1/10; G01J 3/00; G01N 21/55

(52) U.S. Cl. 356/243.4; 356/300; 356/448

(57) ABSTRACT

The invention relates to a device for use in analysing the performance of a spectrometric system of the type which comprises a spectrometer to which a probe for propagating electromagnetic radiation is connected. The device comprises a holder for holding both a reflectance standard and the probe so that the tip of the probe is fixated at a predetermined position relative to the reflectance standard and so that at least part of the electromagnetic radiation emitted from the probe is diffusely reflected from the reflectance standard back to the probe. The invention also relates to a method, a kit and an assembly.

### TECHNICAL FIELD

The present invention relates to a device for use in analysing the performance of a spectrometric system of the type which comprises a spectrometer to which a probe for propagating electromagnetic radiation is connected. The invention also relates to an assembly and a kit for use in such analyses, and to a method for performing such analyses.

### BACKGROUND OF THE INVENTION

Spectrometric systems are used for analysing material characteristics. For instance, in the pharmaceutical industry spectrometric systems may be used for analysing the material characteristics during different stages of a manufacturing process, such as during charging of raw materials, milling, granulation, drying, blending, compression, coating and packaging. In some of these processes the treated material contents may change their characteristics. For instance, in a granulation process, solid materials may be mixed with a liquid, wherein the liquid bounding state, the liquid contents, the temperature and density of the mixture is changing as the process progresses. In a drying process the liquid content is reduced, and the density and the temperature may change during the process. A coating process may be performed either in a fluidised bed wherein particles, so-called nuclei, are sprayed with a specific coating liquid, or by passing the particles through a spray dust of said liquid, or by other generally used coating techniques, such as melting, aggregation etc., wherein the material characteristics may change as the coating process progresses. Thus, there are a number of applications in which spectroscopic measurements may be used for providing information about the characteristics or properties of the material measured upon. Some examples of implementation of spectroscopic measurements are, for instance, illustrated in the international patent applications WO 02/33381 and WO 02/061394.

Some examples of different types of spectrometry are near-infrared (NIR), infrared, microwave, ultraviolet (UV), visible light and Raman spectrometry.

When using a spectrometric system for monitoring or analysing material characteristics, it is desirable to have confidence in the performed measurements and the results obtained. Therefore, when spectrometric measurements indicate that some kind of change has occurred, it is of relevance to know if this change is attributed to a change in characteristics of the monitored material or to a change in the spectrometric system itself. There are suppliers of spectrometric systems who provide means for testing the performance of their equipment The means for testing may include a software which analyses a spectrum obtained by performing spectrometric measurements. However, these means for testing have a limited capability of providing information related to the light path external to the spectrometer, such as providing information related to the condition of a probe and fibre optics system connected to the spectrometer. Commonly, only noise within a sample loop is checked. For instance, if a sample detector which is internal to the spectrometer has a seal failure resulting in formation of condensation, the supplier's means of testing will not detect such an error. It would be desirable to improve the testing of the performance of a spectrometric system, wherein the testing is not limited to just the actual spectrometer but which also encompasses externally connected parts such as a probe.

### SUMMARY OF THE INVENTION

An object of the present invention is to alleviate the drawbacks of the currently used means for testing the performance of a spectrometric system. Another object of the present invention is to make it possible to test the quality of external parts connected to the spectrometer of a spectrometric system. These and other objects which will become apparent in the following are accomplished by a device, an assembly, a kit and a method as defined by the independent claims.

The present invention is based on the insight that the entire light path may be monitored by emitting electromagnetic radiation from the spectrometric system and allowing the radiation to reflect back to the system for measurement and comparison with previous measurements. Thus, by allowing the entire light path to participate in the measurements, a failure along said light path may be detected, irrespectively of whether it is a path along which electromagnetic radiation is propagated away from a radiation emitting unit of a spectrometer or a path along which the reflected radiation is propagated back to a detecting unit of the spectrometer. The invention is also based on the insight that by providing the same conditions from one testing occasion to another, any change in the spectrometric system may be detectable during performance of a test.

In order to enable a substantially consistent reflection of radiation from one testing occasion to another, the emitted electromagnetic radiation may be diffusely reflected on a known reference surface or reference volume, such as a reflectance standard, which reflects a substantially known amount of incident radiation. Also, the distance that the radiation travels from the spectrometric system before it re-enters the system after reflection may be made consistent.

According to one aspect of the invention a device is provided for use in analysing the performance of a spectrometric system of the type which comprises a spectrometer to which a probe for propagating electromagnetic radiation is connected. The device comprises a holder which is dimensioned and configured to hold both a reflectance standard which has a reflecting portion for receiving incident electromagnetic radiation and for diffusely reflecting at least part of said radiation, and the probe so that the tip of the probe is fixated at a predetermined position relative to the reflectance standard and so that at least part of the electromagnetic radiation emitted from the probe is diffusely reflected from the reflectance standard back to the probe. The reflectance standard may be a photometric reflectance standard or a wavelength reflectance standard.

Thus, when the staff at an industrial site, such as a pharmaceutical manufacturing plant, wishes to check the performance of the spectrometric system used for measuring material characteristics, the probe may be disconnected from the measuring location and fixed in the holder at a predetermined distance from a reflectance standard. By having a holder which is capable of holding both the probe and the reflectance standard a consistent testing set-up is obtainable for the staff from one testing occasion to another. The distance between the probe and the reflectance standard may be chosen as desired, suitably in such way that clear readings of the measurement results may be obtained. It should be noted that, in this application, the term “distance” is not only limited to a spaced relationship between the probe and the reflectance standard, but should be understood to also include a zero value, i.e. the tip of the probe being in contact with the reflectance standard. Whichever distance is chosen by the staff, one or more calibrating measurements are suitably performed, to form a basis against which subsequent tests may be compared in the future.

The holder may suitably comprise a first holder part and a second holder part. The first holder part may have a proximal end and a distal end, and be adapted to hold the reflectance standard. The second holder part may be adapted to hold the probe so that the tip of the probe is fixated at said predetermined position relative to the reflectance standard, wherein said proximal end of the first holder part is facing said second holder part. In the context of this application, when the holder holds both the probe and the reflectance standard, the probe is located proximally of the reflectance standard, and conversely the reflectance standard is located distally of the probe.

The first and second holder parts may be made in one piece. Alternatively they may be connected via a pivotable hinge portion, e.g. for allowing the probe to be received by the second holder part when a mating face of the second holder part is pivoted away from a mating face of the first holder part. Thereafter, the second holder part may be pivoted back so as to face the first holder part, thereby aligning the probe for transmitting radiation towards the reflectance standard when the latter is held by the first holding part.

Even though the above alternatives are conceivable it may at some time be advantageous to be able to handle the first and second holder parts separately. Therefore, according to at least one embodiment of the invention, the first holder part and the second holder part are releasably connectable to each other. This embodiment provides several alternative ways of setting up the performance testing. For instance, the two holder parts may be connected to each other before the probe and the reflectance standard are received in the holder parts. Alternatively, the probe and the reflectance standard may each be received in its respective holder part, before the holder parts are connected to each other. Another alternative is to provide one of the components in its holder part, e.g. providing the probe in the second holder part and then connect the second holder part to the first holder part before the reflectance standard is received by the first holder part, or instead providing the reflectance standard in the first holder part, and then connect the first holder part to the second holder part before the probe is received by the second holder part. This embodiment also provides several alternative ways of attaining the fixation of the tip of the probe at a predetermined position relative to the reflectance standard. For instance, the probe and/or the reflectance standard may have a single predetermined position in their respective holder part, wherein the connection between the holder parts may be adjustable so that the distance between the tip of the probe and the reflectance standard is controlled. An alternative is to, on the contrary, have fixed predetermined positional relationship between the two holder parts, wherein the probe and/or the reflectance standard may be arranged at various positions relative to their respective holder part. Another alternative is that both the connection between the holder parts is adjustable so that they can move relative to each other, and the probe and/or reflectance standard are movable to a chosen position in their respective holder part, so as to obtain said predetermined position of the tip of the probe relative to the reflectance standard. Yet another alternative is that the holder parts may only be arranged in a fixed positional relationship to each other, and that the probe and/or reflectance standard may also only be arranged at a fixed relationship to their respective holder part. Thus, the insight of allowing two holder parts to be releasably connectable to each other, and allowing a probe and a reflectance standard to be received by the respective part, provides flexibility and several options in using the invention according to this embodiment.

In order to connect the first holder part and the second holder part, there may be provided cooperating engagement means. For instance, the first holder part may comprise first engagement means and the second holder part may comprise second engagement means which are engageable to each other for preventing, at least in one direction, relative movement between the first and second holder parts. Said at least one direction may generally be the proximal-distal direction, however, rotation movements may suitably also be prevented. The first and second engagement means or cooperating fixing means may comprise an insertable part such as a pin-shaped member and a cooperating receiving part such as a recess; a conical male part having one cone angle cooperating with a mating conical female part having another cone angle so as to achieve frictional locking; a screw and a threaded hole; a bayonet joint; an external thread (e.g. on the first holder part) cooperating with an internal thread (e.g. on the second holder part); or any other suitable engagement means.

The first holder part may suitably define a proximal cavity portion which is dimensioned to receive a mating protruding portion of the second holder part. The mating protruding portion of the second holder part may suitably comprise a hollow for receiving the probe, wherein a portion of the probe will be surrounded by the protruding portion of the second holder part, which in turn will be surrounded by the wall of the cavity portion of the first holder part If desired, the distal end of the protruding portion may be open, or provided with at least a partial opening, for allowing the tip of the probe to be passed through the protruding portion and past the opening into a space of the first holder part. An advantage of this is that the probe may be arranged to come into contact with the reflectance standard or with a window protecting the reflectance standard. This will be discussed again, in more detail, later in this description.

As previously exemplified, there may be provided engagement means such as a pin-shaped member cooperating with a receiving recess. In the case of the previously described protruding portion of the second holder part which is received in the proximal cavity portion of the first holder part said protruding portion may be provided with a recess in its enveloping surface, wherein a pin-shaped member may either project from the wall defining the cavity portion or be passed through said wall in order to engage with the recess, thereby locking the first and second holder parts and limiting relative movement between the two holder parts.

Alternatively, the engagement means may be in the form of cooperating threads. For instance, the enveloping surface of the first holder part may have external threads that are adapted to cooperate with a nut having internal threads, wherein when the nut is tightened relative movement between the holding parts is prevented.

According to at least one embodiment of the invention, the holder comprises a fixing means for arranging a first component at a fixed position in the holder, and an actuator adapted to displace a second component towards said first component. The first component may be either one of the reflectance standard or the probe, and the second component may be the other one of the reflectance standard or the probe. Thus, while one of the components is in a fixed position, the staff performing the test may adjust the position of the other component relative to the first component. The actuator may comprise a spring means which is biased to perform said displacement of one component towards the other. Such a spring means may e.g. comprise a coil, a rubber cushion, a hydraulic compressible volume, or any other suitable arrangement that springs back after having been temporarily deformed. Alternatively, the actuator may be provided without a spring means, e.g. in the form of a push-rod having a linear non-rotating motion or in the form of a screw-rod which is screwed along a threaded path for pushing of the component or any other suitable actuators which may be manually or electrically driven. This presented embodiment may be implemented regardless of whether the holder comprises first and second holder parts, and regardless of whether such holder parts are releasably connectable to each other or are provided as one piece.

It has been found suitable to provide an actuator comprising a spring means for displacing the reflectance standard towards the probe. According to at least one embodiment of the invention, the device comprises a space for receiving the reflectance standard, wherein the actuator with the spring means is adapted to act on the reflectance standard when received in said space. The tip of the probe may be releasably fixed at a fixed position in the holder by said fixing means. Even if the space is made large relative to is the reflectance standard, for facilitating the positioning of the reflectance standard in the space, the reflectance standard may be displaced into the desired position in said space by means of the actuator. The spring means may be loaded by temporarily deforming it before the reflectance standard is put into the space. Alternatively, when being inserted into the space, the reflectance standard may cause the spring means to be temporarily deformed before it springs back to displace the reflectance standard.

Suitably, the spring means comprises a rod assembly comprising a proximal end portion facing the reflectance standard, a distal end portion, and an intermediate rod portion which is displaceable through a hole at the distal end of the holder. A spring acts on the rod assembly so that the proximal end portion of the rod assembly, which is displaceable within said space, is enabled to displace the reflectance standard towards the probe. The rod assembly may be in the form of a simple rod, or a rod having an endplate with an enlarged diameter for contactingly pushing the reflectance standard. By allowing a portion of the rod assembly to be displaceable through a hole at the distal end of the holder and having the distal end portion of the rod assembly outside the distal end of the holder, an operator may grip the distal end of the rod assembly in order to pull the rod assembly in a distal direction and providing room for the reflectance standard to be inserted into the space.

In this application a reflectance standard shall not be limited to such reflectance standards which may be commercially available, but also modified reflectance standards, e.g. such that have been encapsulated in a casing. Thus, when discussing pushing, contacting or other handling of a reflectance standard it is to be understood that it may also include indirect handling of the reflectance standard, e.g. pushing or contacting a casing in which the reflectance standard is encapsulated.

According to at least one embodiment of the invention, the device comprises a guide for guiding the probe. Even though the guide may be devised in various ways, e.g. as a series of rings or lateral delimitations, in the following example the guide will be presented as a channel for guiding the probe. The channel has a proximal end through which the probe is introducible and a distal end through which the tip of the probe is protrudable for contacting the reflectance standard or for contacting a protective layer covering the surface of the reflectance standard. The shape and cross-sectional dimension of the channel is preferably dimensioned to substantially correspond to the outer dimensions of the probe. The channel facilitates the fixation of the probe, while allowing the tip of the probe to be accessible to the reflectance standard or a protective layer in front of the reflectance standard. By arranging the probe in contact with the reflectance standard the predetermined zero distance is obtainable each time of testing the spectrometric system. If the reflectance standard is protected by a protective layer, such as a sapphire glass window, the probe may be arranged to contact that layer each time of testing. Since the protective layer is either provided in direct contact with the surface of the reflectance standard, or at a known fixed non-zero distance therefrom, the predetermined distance between the tip of the probe and the reflectance standard may remain unaltered from one testing occasion to another. This presented embodiment may be implemented regardless of whether the holder comprises first and second holder parts, and regardless of whether such holder parts are releasably connectable to each other or are provided as one piece.

Suitably the channel is defined by an adjustable collar or collet which is adapted to be tightened around the probe for holding the tip of the probe in a fixed position. The collar may be tightened by means of a clamp, a screw or any other suitable arrangement for clamping the probe to the collar.

Suitably, the collar or collet is tightened by means of a nut which is adapted to come into contact with the proximal end of the collar or collet. The nut comprises internal threads for cooperating with external threads on the enveloping surface of the first holder part.

The advantage of providing a protective layer that covers the surface of the reflectance standard is not limited to embodiment with the channel for guiding a probe. It may on the contrary be used in many different designs. Thus, in more general terms, according to at least one embodiment of the invention, the tip of the probe is fixated at a predetermined position relative to the reflectance standard by providing such a protective layer at a fixed relationship to the reflectance standard, e.g. in contact with the reflectance standard, and by enabling the tip of the probe to come into contact with said protective layer. The protective layer will not only protect the surface of the reflectance standard, but will assist in defining said predetermined distance.

As mentioned previously, the reflectance standard may be acted upon indirectly, by enclosing the reflectance standard in a casing. In such case the holder is adapted to indirectly hold the reflectance standard by holding the casing. Suitably, the casing is provided with an aperture which allows incident electromagnetic radiation to reach the reflectance standard, and with a protective window covering the reflectance standard. The protective window may correspond to the previously discussed protective layer. The protective window or protective layer may be made of an at least partly transparent material, such as of sapphire glass, and durable with regard to repeated contacts with the tip of the probe over a number of testing occasions.

Suitably, the light aperture in the casing has a diameter which is large enough for enabling the tip of the probe to be introduced therethrough. When introduced through the aperture, the probe may come into contact with the protective window. Suitably, when the device is in use, the central axis of the probe is aligned with the central axis of the reflectance standard, and the centre of the aperture, for facilitating smooth introduction of the tip of the probe through the aperture. Also, in order to have this alignment consistent at each testing occasion, the reflectance standard, or its enclosing casing, has a transverse dimension relative to the central axis which substantially corresponds to the inner transverse dimension of the space where it is positioned. In other words, suitably, the reflectance standard is substantially unmovable in the transverse direction when located within the holder.

It should be noted that even though it may be convenient to use a protective window with which the tip of the probe may come into contact in order to obtain a known distance between the tip of the probe and the reflectance standard, there are other alternatives for obtaining a distance that is consistent from one measurement occasion to another. For instance, according to at least one embodiment of the invention, the device or the holder comprises an abutment which limits the displacement of the reflectance standard towards the probe. Suitably, in the case of a holder comprising the previously discussed first and second holder parts, the first holder part may be provided with the abutment in order to limit the displacement of the reflectance standard within the first holder part towards the proximal end of the first holder part. Advantageously, the reflectance standard is displaceable towards said abutment by means of an actuator, such as one having a spring means as previously discussed, which may be used to urge the actuator to push the reflectance standard towards said abutment and keeping it in place when the abutment prevents the reflectance standard from further motion. In case of such a spring means being present, the reflectance standard may be removable from the housing after withdrawing the actuator against the force of the spring means. While the abutment defines a location for the reflectance standard, a fixing means may be used to define a location for the tip of the probe, e.g. a tapering channel which allows the probe to be inserted only to a certain point The skilled person will understand that there are also other alternatives possible for obtaining a predetermined distance between the tip of the probe and the reflectance standard.

The holder of the device may be designed in various ways for holding a reflectance standard. It may, for instance, be in the form of an open construction which just holds the back of the reflectance standard. Suitably, such an open construction is subsequently covered in appropriate manner so as to reduce background noise from ambient light. Alternatively, a comparatively closed construction may be provided for accommodating the reflectance standard. Such a construction is provided according to at least one embodiment, wherein the device comprises a housing which is provided with an opening for receiving and removing the reflectance standard. According to this embodiment, the device also comprises a light guard for reducing the amount of light entering the housing through said opening, wherein the light guard is movable between a covering position in which the light guard at least partially covers said opening and an exposing position in which said opening is exposed for receiving or removing the reflectance standard. The light guard may be in the form of a cylinder which surrounds the housing, wherein the cylinder has an opening which may be aligned with the opening of the housing when the light guard has been rotated to the exposing position. Instead of a cylinder a curved sheet may be provided as a light guard, wherein the sheet may follow the contour of the housing and be displaceable in the circumferential direction of the housing. Alternatively, the light guard may be in the form of a hatch which is connected to the housing via a hinge, which is pivotable between a closed covering position and an open exposing position. Another alternative light guard would be a sliding hatch or cylinder which is movable in a straight line along the housing for covering or exposing the opening of the housing. Alternatively, any other suitable light guard may be provided, such as a separate plug which is inserted into the opening for covering it or removed for exposing it.

The idea of using a housing may be combined with the previously presented idea of using an abutment According to at least one embodiment of the invention, the device comprises a housing within which an abutment limits the displacement of the reflectance standard in the proximal direction towards the probe. Suitably, the housing is provided with an opening for receiving and removing the reflectance standard, wherein said opening is distally spaced from the absent by a wall portion of the housing. Advantageously, the housing comprises a first cavity portion which is dimensioned to receive the reflectance standard and which extends distally of said abutment, and a second cavity portion which is dimensioned to receive a mating portion, such as in the form of a protrusion, of the second holder part (in the case of a device having first and second holder parts) and which extends proximally of said abutment. Suitably, the second cavity portion has a smaller diameter than said first cavity portion in accordance with the dimensions of the components to be accommodated in the respective cavity portion.

The previously described device according to the first aspect of the invention, and any one of its presented embodiments, may form part of an assembly for use in analysing the performance of a spectrometric system. Thus, according to a second aspect of the invention an assembly is provided for use in analysing the performance of a spectrometric system of the type which comprises a spectrometer to which a probe for propagating electromagnetic radiation is connected. Apart from the previously presented device, the assembly also comprises a reflectance standard adapted to be held by the device, the reflectance standard having a reflecting portion for receiving incident electromagnetic radiation from the probe and diffusely reflecting at least part of said radiation to the probe.

Suitably, the reflectance standard of the assembly is provided enclosed in a casing which is adapted to be received and removed from the device. This facilitates handling of the reflectance standard and reduces the risk of inadvertent damage being caused to the reflectance standard.

Similarly to the earlier description of the casing, also in the second aspect of the invention, the casing may, according to at least one embodiment, be provided with an aperture which allows incident electromagnetic radiation to reach the reflectance standard, and with a protective window covering the reflectance standard, the protective window being transparent to the incident electromagnetic radiation. Suitably, the aperture has a diameter which is large enough for enabling the tip of the probe to be introduced therethrough so as to come into contact with the protective window.

Any other details discussed in connection with the summary of the first aspect of the invention should be understood to be applicable also to the assembly according to the second aspect of the invention.

According to a third aspect of the invention a kit is provided for use in analysing the performance of a spectrometric system of the type which comprises a spectrometer to which a probe for propagating electromagnetic radiation is connected, the probe having one of a plurality of possible diameters. The kit comprises a first holder part for holding a reflectance standard which has a reflecting portion for receiving incident electromagnetic radiation and diffusely reflecting at least part of said radiation. The kit also comprises a plurality of second holder parts each one of said second holder parts being releasably connectable to the first holder part and adapted to hold a probe so that the tip of the probe is fixated at a predetermined position relative to the reflectance standard and so that at least part of the electromagnetic radiation emitted from the probe is diffusely reflected from the reflectance standard back to the probe, wherein at least one of said second holder parts is adapted to hold a probe that has a different diameter than a probe which the rest of the second holder parts are adapted to hold.

The third aspect of the invention allows for convenient handling and testing of different probe sizes. Some spectrometric systems may have one type of probe of a first diameter while others may have another type of probe of another diameter. Some spectrometric systems may even have interchangeable probes wherein the operator can choose with which type of probe he or she wishes to take measurements. The kit allows for analysing any one of these spectroscopic systems. In this application, the term “plurality” is shall be understood to mean two or more.

Suitably, the different second holder parts are configured so as to fit a respective probe size. According to at least one embodiment of the invention, each one of said second holder parts comprises a channel for guiding the probe, wherein the channel of at least one of said second holder parts has a different cross-sectional dimension than the respective channel of the rest of said second holder parts. The channel may either have an open or a closed periphery. For a closed periphery, the cross-section of the channel may be circular, wherein the inner diameter of the channels will be different for different second holder parts. The cross-section may, however, as an alternative, be or comprise a part of a circle, such as a semi-circle, wherein the inner radius of the channels will be different for different second holder parts. Other cross-sectional geometries, such as polygons, are also conceivable.

The kit according to the third aspect of the invention may, according to at least one embodiment thereof, also comprise a plurality or reflectance standards, wherein at least one of said plurality of reflectance standards has a different reflectance than the rest of said plurality of reflectance standards. Thus, depending on circumstances, such as wavelength or intensity of the electromagnetic radiation transmitted from the probe, a suitable reflectance standard may be chosen from the kit. Different reflectance standards of different reflectance may be used to test the instrument for consistent performance over the required operating range of the instrument. Suitably, the second holder parts are not limited for use with a specific reflectance standard, but any combination of kit components may be made.

According to at least one embodiment of the kit, when the first holder part and any one of said second holder parts are connected they are in the form of a device as previously presented with regard to the discussion of the first aspect of the invention. Thus, any combination of structural and/or functional features of the device according to the first aspect of the invention may, if compatible, be incorporated in a kit according to the third aspect of the invention.

According to a fourth aspect of the invention a method if provided for analysing the performance of a spectrometric system of the type which comprises a spectrometer to which a probe for propagating electromagnetic radiation is connected. The method comprises:

providing a reflectance standard which has a reflecting portion for receiving incident electromagnetic radiation and diffusely reflecting at least part of said radiation,

fixating the tip of the probe at a predetermined position relative to the reflectance standard so that at least part of the electromagnetic radiation emitted from the probe is diffusely reflected from the reflectance standard back to the probe,

emitting an electromagnetic radiation from the spectrometer via the probe to the reflectance standard, and

analysing the electromagnetic radiation which is diffusely reflected back to the spectrometer via the probe.

Suitably, the act of analysing the diffusely reflected electromagnetic radiation comprises comparing its values with one or more reference values. Such reference values may have been obtained during earlier tests of the spectrometric system or during an initial calibration. If the values of the diffusely reflected electromagnetic radiation differs more than a set range around the reference values, it may be an indication of a system failure, e.g. a defective probe.

According to at least one embodiment of the method, the probe is passed through a channel so that the tip of the probe protrudes from the channel and comes into contact with the reflectance standard or a protective window covering the reflectance standard.

According to at least one embodiment of the method, the reflectance standard is first inserted into a housing and then displaced within the housing towards the tip of the probe. This may be accomplished in various ways. For instance, the reflectance standard is inserted in a radial direction of the housing then displaced in the longitudinal or axial direction of the housing. Suitably, the displacing of the reflectance standard is performed by means of spring force. Another alternative, would be an axial insertion and then a rotation of the reflectance standard for locking with e.g. threads or a bayonet joint. Any other way of introducing the reflectance standard into the housing and reducing the risk of it inadvertently falling out of the housing is conceivable, wherein such ways include an insertion in one direction and a subsequent displacement in another direction (including angular directions).

According to at least one embodiment, the method comprises holding the probe and the reflectance standard with a device previously presented with regard to the discussion of the first aspect of the invention. Thus, any combination of structural and/or functional features of the device according to the first aspect of the invention may, if compatible, be used in a method according to the fourth aspect of the invention.

According to a fifth aspect of the invention a device is provided for analysing the performance of a spectrometric system of the type which comprises a spectrometer to which a probe for propagating electromagnetic radiation is connected. The device comprises a probe holder for holding the probe. The device also comprises a movable support for supporting a reflectance standard unit. The reflectance standard unit comprises a reflectance standard having a reflecting portion for receiving incident electromagnetic radiation from the probe and diffusely reflecting at least part of said radiation back to the probe. The support is movable towards the probe for making the reflectance standard unit come into contact with the tip of the probe.

By allowing the reflectance standard unit to come into contact with the tip of the probe each time an analysis of performance of the spectrometric system is made, the distance between the tip of the probe and the reflectance standard will be the same each time. The reflectance standard unit is suitably movable along the same axis in which the tip of the probe is pointing.

The support is suitably spring-suspended, e.g. by means of a spring means as described in connection with the discussion of the first aspect of the invention. Likewise, the support may be in the form of an end portion, such as a plate, of the previously described rod assembly, or in the form of a partly enveloping seat or any other suitable means for movably supporting the reflectance standard unit.

Advantageously, the reflectance standard unit comprises a protective layer, such as a sapphire glass window, which covers the reflectance standard, wherein the support is movable towards the probe for making the protective layer come into contact with the tip of the probe. The reflectance standard unit may comprise a casing enclosing the reflectance standard, similarly to that described in connection with the discussion of the first aspect of the invention.

Furthermore, the device according to the fifth aspect of the invention may comprise any structural and/or functional feature which is compatible with the device according to the first aspect of the invention.

According to a sixth aspect of the invention a method is provided for analysing the performance of a spectrometric system of the type which comprises a spectrometer to which a probe for propagating electromagnetic radiation is connected. The method comprises:

holding the probe, the tip of the probe pointing along a geometrical axis,

providing a reflectance standard which has a reflecting portion for receiving incident electromagnetic radiation and diffusely reflecting at least part of said radiation,

arranging the reflectance standard on said geometrical axis in front of the tip of the probe,

displacing the reflectance standard along said geometrical axis so that it, or a protective layer, such as a sapphire glass window, that covers and follows any motion of the reflectance standard, comes into contact with the probe,

emitting an electromagnetic radiation from the spectrometer via the probe to the reflectance standard, and

analysing the electromagnetic radiation which is diffusely reflected back to the spectrometer via the probe.

Any combination of structural and/or functional features presented for any one of the other aspects of the invention may, if compatible, be used in a method according to the sixth aspect of the invention.

According to a seventh aspect of the invention a method is provided for positioning a bundle of fibres of a probe relative to a tip of the probe, said probe being connected to a spectrometer and being adapted to propagate electromagnetic radiation through the fibres, the method comprising

providing a reflectance standard which has a reflecting portion for receiving incident electromagnetic radiation and diffusely reflecting at least part of said radiation,

fixating the tip of the probe at a predetermined position relative to the reflectance standard so that at least part of the electromagnetic radiation emitted from the probe is diffusely reflected from the reflectance standard back to the probe,

emitting an electromagnetic radiation from the spectrometer via the probe to the reflectance standard,

moving the bundle of fibres relative to the tip of the probe to different positions, and

determining in which of the positions the bundle of fibres propagates the highest amount of electromagnetic radiation, which has been diffusely reflected, back to the spectrometer.

Any combination of structural and/or functional features presented for any one of the other aspects of the invention may, if compatible, be used in a method according to the seventh aspect of the invention.

Even though it may be suitable to allow the reflectance standard to be removably adapted into the holder, it should be understood that, as an alternative, any aspect of the invention also encompasses the provision of a non-removable reflectance standard. In such case, the reflectance standard has been fixedly arranged in the holder and is not adapted to be removed or exchanged for another one.

It should also be understood that even though the invention suitably involves the use of reflectance standards, which are generally commercially available and have a certified reflectance, the invention is not limited to such use. The invention also encompasses using any other reference material which has a known reflectance and which, similarly to a reflectance standard, has a reflecting portion for receiving incident electromagnetic radiation and diffusely reflecting at least part of said radiation.

### BRIEF DESCRIPTION OF THE DRAWINGS

FIG. 1 illustrates schematically a spectrometric system, comprising a spectrometer to which a probe is connected for taking measurements in a process vessel.

FIG. 2 illustrates schematically the probe removed from the process vessel and instead inserted into a device for use in analysing the performance of the spectrometric system.

FIG. 3 is an exploded perspective view of an embodiment of a performance analysing assembly and device according to the present invention.

FIG. 4 is an exploded cross-sectional view of the embodiment shown in FIG. 3.

FIG. 5 is a partly cross-sectional view illustrating the mounting of a probe and a reflectance standard to a device according to one embodiment of the invention.

FIGS. 6a-6b is a cross-sectional side-view illustrating a possible way of obtaining a predetermined distance between the tip of the probe and the reflectance standard, if they are mounted in accordance with the illustration of FIG. 5.

FIGS. 7a-7d is a partly cross-sectional view illustrating step by step a slightly different procedure for mounting a probe and reflectance standard to a device according to one embodiment of the invention. With this procedure, the same predetermined distance as illustrated in FIGS. 6a-6b is obtainable.

FIG. 8 illustrates schematically components of a kit according to one embodiment of the invention.

FIG. 9 illustrates another embodiment of a performance analysing assembly and device according to the present invention. The left side of FIG. 9 is an ordinary side view, while the right side of FIG. 9 is a cross-sectional side view.

FIG. 10 is an exploded perspective view of the embodiment illustrated in FIG. 9.

FIGS. 11a-11b illustrate schematically a method of positioning a bundle of fibres of a probe relative to a tip of the probe.

### DETAILED DESCRIPTION OF THE DRAWINGS

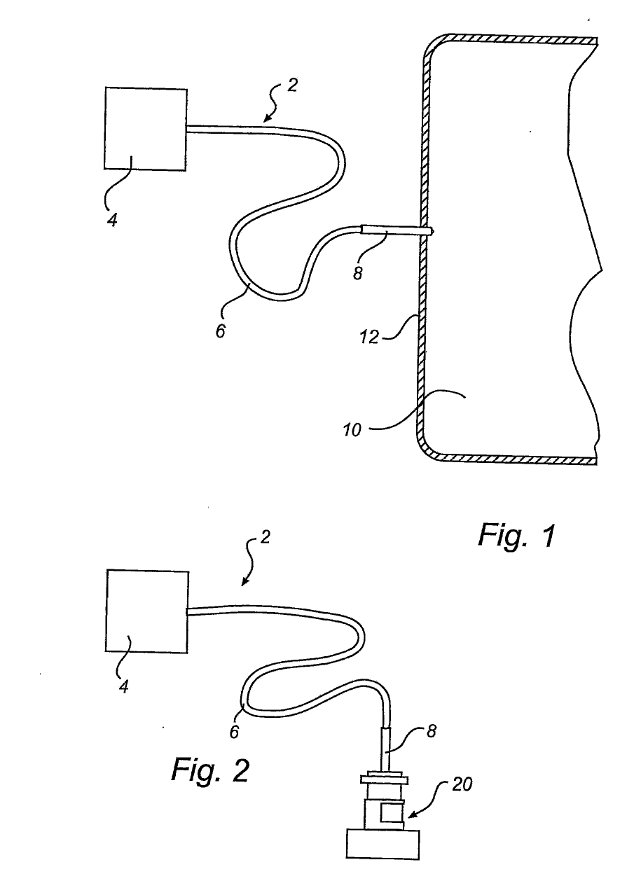

FIG. 1 illustrates schematically a spectrometric system 2, comprising a spectrometer 4 to which an optical probe 6 is connected for taking on-line measurements in a process vessel 10. The spectrometer 4 may be of any standard type. The spectrometer 4 may suitably have an operating range within the NIR spectrum. In the pharmaceutical industry, the use of NIR spectrometers have grown over time. However, it may also be conceivable to implement the present invention in analysing the performance of spectrometers having other operating wavelengths.

The probe 6 is at one of its end portions connected to the spectrometer 4. At its other end portion it comprises a probe head 8 which is passed through a wall 12 of the process vessel 10. Alternatively, the probe head 8 may be located outside a window in the wall 12. The probe 6 comprises one or more optical fibres for guiding electromagnetic radiation from the spectrometer 4 via the probe 6 and into the process vessel 10. The probe 6 also comprises one or more optical fibres for guiding back to the spectrometer 4 electromagnetic radiation that has reflected or scattered back to the probe 6 after interaction with the material in the process vessel 10.

The process vessel 10 may be e.g. a drying vessel. However, granulation vessels, coating vessels or other type of process vessels may also be monitored by spectrometric system which may then be analysed for their performance.

When it is time to analyse the performance of the spectrometric system 2, the probe head 8 is disconnected from the wall 12 of the process vessel 10 and moved to an inventive device 20 for use in analysing the performance of the spectrometric system 2 off-line. This is schematically illustrated in FIG. 2. The measurements performed with the aid of the device 20 are compared with calibrating measurements that have already been carried out.

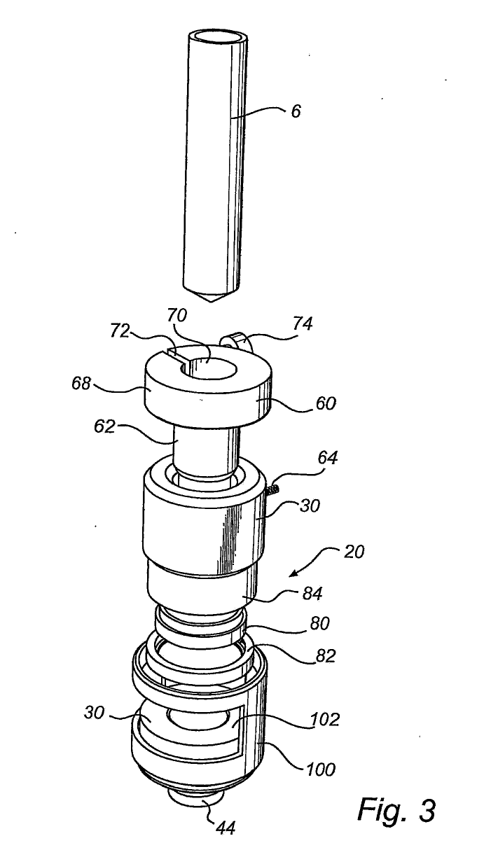

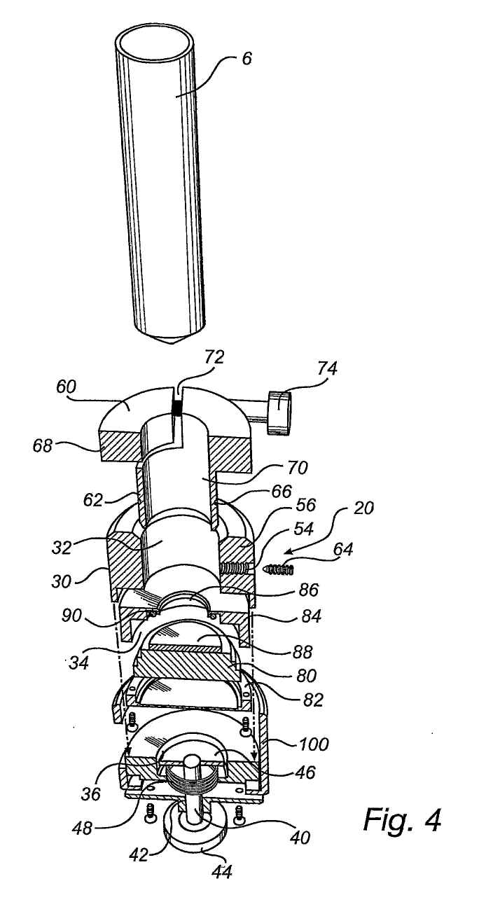

FIGS. 3 and 4 illustrate an assembly comprising a reflectance standard 80 and a device 20 according to one embodiment of the invention. The device 20 comprises a first holder part 30 for holding the reflectance standard 80 and a second holder part 60 for holding the probe 6 (in particular its probe head 8 which was discussed in relation to FIG. 1 and FIG. 2).

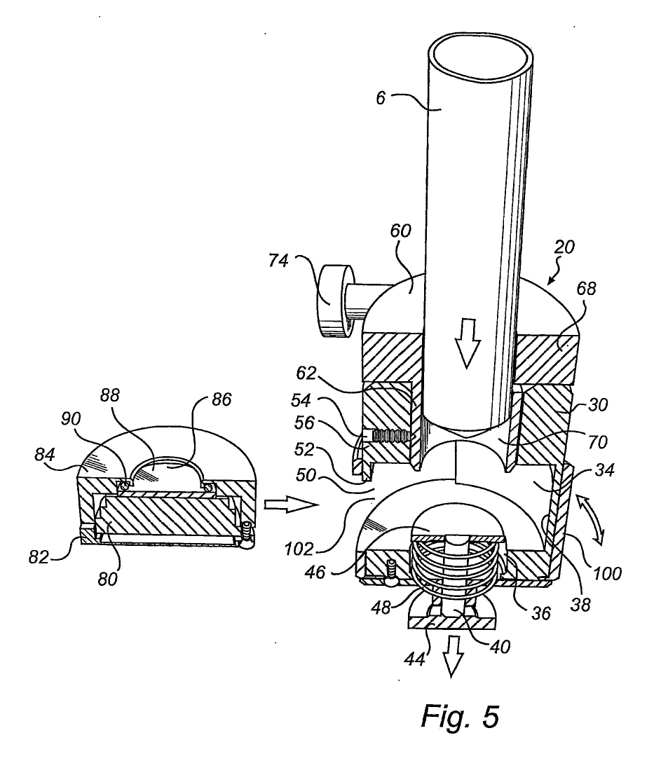

The first holder part is 30 in the form of a metal drum or barrel. The barrel 30 defines three cavity portions. A proximal cavity portion 32, a central cavity portion 34 and a distal cavity portion 36. The exploded view of FIG. 4 shows for the sake of clarity the cavity portions 32, 34, 36 being spaced from each other. However, in reality, they are directly adjacent to each other and the laterally delimiting wall 38 of the barrel 30 defining these cavity portions 32, 34, 36 is in one piece, which is indicated by the arrows in FIG. 4, and which is clear from FIGS. 5-7.

The distal cavity portion 36 may accommodate an actuator in the form of a spring-loaded rod assembly. The rod assembly comprises a cylindrical rod 40 which is displaceable through a hole 42 provided at the distal end of the barrel 30. The distal end of the rod 40 is provided with a handle or gripping means 44 which is located outside the barrel 30 and which has a larger diameter than the hole 42. An operator may grip the gripping means 44 in order to pull the rod assembly in a distal direction. The proximal end of the rod 40 is provided with a circular support plate 46 for supporting a reflectance standard. A coil spring 48 is flitted between the support plate 46 and the distal end of the barrel. After becoming compressed and then released, the spring 48 urges the support plate 46 to move in a proximal direction. The diameter of the support plate 46 is slightly smaller than the diameter of the distal cavity portion 36 so as to allow the support plate 46 to be retracted into the distal cavity portion 36 when an operator pulls the gripping means 44 of the rod assembly.

The central cavity portion 34 of the first holder part 30 is dimensioned to receive and accommodate a reflectance standard 80. When an operator retracts the support plate 46 into the distal cavity portion 36, the central cavity portion 34 becomes readily accessible for insertion of the reflectance standard 80. The reflectance standard 80 is insertable through an opening 50 in the circumferential wall of the barrel 30 (see FIG. 5), the opening 50 being in direct communication with the central cavity portion 34. Thus, after insertion through the opening 50 and into the central cavity portion 34, the barrel 30 acts as a housing to the reflectance standard 80. The opening 50 does not expose the entire central cavity portion 34, rather a proximal wall portion 52 defining the central cavity portion 34 extends all the way circumferentially of the central cavity portion 34. The opening 50 extends distally to that proximal wall portion 52. When the reflectance standard 80 has been introduced into the central cavity portion 34, the operator may release the gripping means 44 so as to allow the spring 48 to urge the support plate 46 and the reflectance standard 80 supported on said support plate 46 to become proximally displaced. The reflectance standard 80 will therefore move slightly away proximally of the opening 50, wherein the proximal front portion of the reflectance standard 80 will become enclosed by the circumferential proximal wall portion 52 of the central cavity portion 34. This circumferential proximal wall portion 52 will limit any lateral movement, and together with the support plate 46 keep the reflectance standard 80 in the central cavity portion 34 of the barrel 30.

The reflectance standard 80 has been provided with a protective casing which has a bottom end cap 82 and a cylindrical cup part 84. When connected to the bottom end cap 82, the cylindrical cup part 84 encloses the reflectance standard 80 (see also FIG. 5). A central aperture 86 in the cup part 84 is provided for allowing electromagnetic radiation to be introduced into and diffusely reflected from the reflectance standard 80. Within the casing, a circular sheet of sapphire glass 88 is provided on top of the reflectance standard 80 for further protection of the reflectance standard 80, the sapphire glass 88 being at least partly transparent to electromagnetic radiation. Above the sapphire glass 88 a rubber O-ring 90 is provided in circular groove of the cup part 84. The O-ring 90 holds and protects the sapphire glass 88. Suitably, for performance monitoring of the spectrometric system, the tip of the probe 6 may be arranged in contact with the sapphire glass 88, i.e. the size of the aperture 86 may be larger than the width of the tip of the probe 6. However, the aperture 86 of the casing may be made such that the tip of the probe 6 does not extend all the way to the sapphire glass 88, e.g. leaving a gap of a few micrometers between probe 6 and glass 88. Such a defined gap may be accomplished in other ways as well, e.g. by providing a circular rubber buffer onto the sapphire glass, so that the probe will abut the rubber buffer rather than the sapphire glass.

The proximal cavity portion 32 has a smaller diameter than the central cavity portion 34, thereby preventing the reflectance standard 80 from entering into the proximal cavity portion 32. The proximal cavity portion 32 forms part of an engagement means for connecting the first holder part 30 to the second holder part 60. The proximal cavity portion 32 is configured and dimensioned to receive a mating cylindrical protruding portion 62 of the second holder part 60. A screw 64 is driven through a threaded through-hole 54 which penetrates the wall portion 56 that defines the proximal cavity portion 32 of the first holder part 30. When the cylindrical protruding portion 62 of the second holder part 60 is inside the proximal cavity portion 32 of the first holder part 30, the screw 64 will engage with a circumferential recess 66 formed in the outer surface of the cylindrical protruding portion 62, thereby securing the holder parts 30, 60 to each other. The holder parts 30, 60 may be disconnected after removing the screw 64 from the recess 66.

Apart from the cylindrical protruding portion 62, the second holder part 60 also comprises an adjustable portion 68 located proximally of and having a larger cross-sectional dimension than the protruding portion 62. A central channel 70 extends from the proximal to the distal end of the second holder part 60, i.e. through both the adjustable portion 68 and the protruding portion 62. The channel 70 has a function of guiding the probe 6 to the desired position. The channel 70 has also a function of fixating the probe 6 inside the second holder part 60. The fixating function may be achieved by reducing the cross-sectional dimension of the channel 70, such as its diameter, after the probe 6 has been introduced therethrough and brought to the desired position. In the illustrated example, the second holder part 60 is in the form of an adjustable collar or clamp. As may be seen from FIG. 4, a slit 72 is provided in the adjustable portion 68. The slit 72 extends from the proximal end of the adjustable portion 68 towards the protruding portion 62. At the transition between the adjustable portion 68 and the protruding portion 62, the extension of the slit 72 diverges and continues in the circumferential direction. The width of the slit 72, and thereby the cross-sectional dimension of the channel 70, can be adjusted by means of a tightening screw 74 which is provided at the adjustable portion 68 and which bridges the slit 72. After the probe 6 has been inserted into the second holder part 60, the adjustable portion 68 may be tightened with the tightening screw 74, which will cause the width of the slit 72 to become reduced and thereby also reducing the size of the channel 70. Thereby, the channel wall may engage the probe 6 so that the probe 6, or at least its tip portion, is held in a fixed position.

While it is desirable to have an adequate propagation path of electromagnetic radiation between the probe 6 and the reflectance standard 80, it may be desirable to reduce other electromagnetic radiation which may cause noise in the measurements. Therefore, a light guard 100 is provided in order to reduce the amount of light entering through the opening 50 of the barrel 30 when the barrel 30 holds the reflectance standard 80 for use in analysing the performance of a spectrometric system. The light guard 100 may be of any suitable type as long as it can cover the opening 50 of the barrel 30. In the example illustrated in FIG. 5 the light guard 100 is in the form of a rotatable metal cylinder coaxially surrounding the barrel 30. The light guard 100 has an opening 102, the size of which, suitably, corresponds or exceeds the opening 50 in the barrel 30, even though a smaller size may be conceivable. When the opening 102 in the light guard 100 is located in front of the opening 50 in the barrel 30, the reflectance standard 80 may be inserted into the barrel 30. Thereafter, when the reflectance standard 80 has been inserted into the barrel 30, the light guard 100 is rotated so that the opening 50 of the barrel 30 is covered by a cylindrical wall portion of the light guard 100 so as to reduce light from entering the barrel 30.

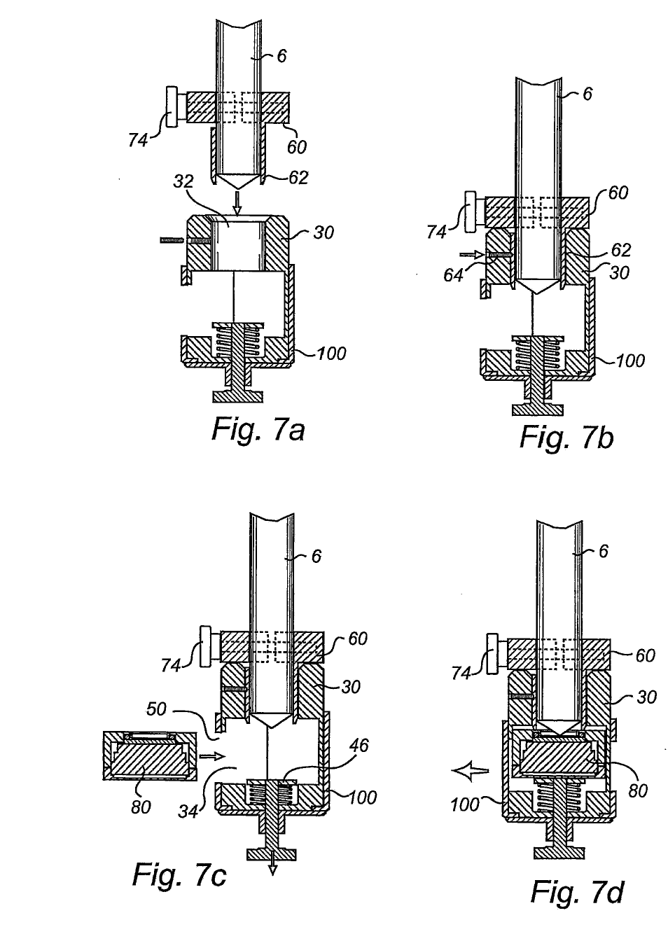

In FIG. 5 the probe 6 is illustrated as being inserted into the device 20 after the two holder parts 30, 60 have been connected. However, it could also first be inserted into the second holder part 60 before the second holder part 60 is connected to the first holder part 30. This will be illustrated in FIGS. 7a-7d.

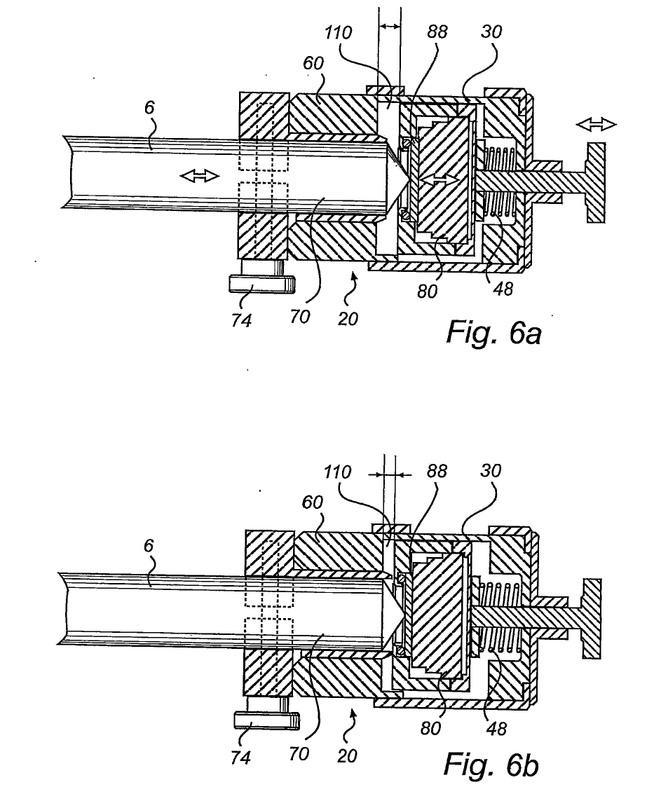

If the probe 6 is inserted into the device 20 after the two holder parts. 30, 60 have been connected, as illustrated in FIG. 5, the predetermined distance between the tip of the probe 6 and the reflectance standard 80 may be obtained as illustrated in FIG. 6a and FIG. 6b. When the two holder parts 30, 60 have been connected, the reflectance standard 80 is inserted into the first holder part 30 (the barrel), as previously described. Next, the probe 6 is inserted through the channel 70 of the second holder part 60 and is advanced so that the tip of the probe 6 touches the reflectance standard 80 or suitably the protective sapphire glass 88, if provided. In order to make sure that the tip of the probe 6 has indeed reached the protective sapphire glass 88, the operator may continue to advance the probe 6 until a resistance is sensed due to the force of the spring 48 which becomes compressed as the reflectance standard 80 is pushed by the probe 6. This movement is illustrated by FIG. 6a, indicating a space 110 proximally of the reflectance standard 80. Thereafter, the operator may allow the reflectance standard 80 and probe 6 to slightly spring back to a balanced position, whereafter the tightening screw 74 is used to secure the probe 6 in that position, keeping the tip of the probe 6 in contact with the protective sapphire glass 88. This is illustrated in FIG. 6b, wherein the space 110 proximally of the reflectance standard has become smaller.

FIGS. 7a-7d is a partly cross-sectional view illustrating step by step a slightly different procedure for mounting a probe 6 and reflectance standard 80 to a device according to one embodiment of the invention. With this procedure, the same predetermined distance as illustrated in FIG. 6 is obtainable. As illustrated in FIG. 7a, before connecting the first holder part 30 and the second holder part 60, the second holder part 60 has already been provided with the probe 6 and the tightening screw 74 has been adjusted so that the probe 6 is held firmly. Next, as illustrated in FIG. 7b, the second holder part 60 is connected to the first holder 30 part by inserting the protruding portion 62 of the second holder part 60 into the proximal cavity portion 32 of the first holder part 30, and by driving a screw 64 through the threaded through-hole which penetrates the wall that defines the proximal cavity portion 32 of the first holder part 30 so that the screw 64 will engage with the circumferential recess formed in the outer surface of the protruding portion 62. Thereafter, as illustrated in FIG. 7c, the rod assembly and its support plate 46 is retracted so as to make space for receiving the reflectance standard 80 in the central cavity portion 34 of the first holder part 30. When the reflectance standard 80 has been inserted through the opening 50 into the first holder part 30, the rod assembly is released and the support plate 46 will push the reflectance standard 80 in the proximal direction so that it comes in contact with the tip of the probe 6. Finally, as illustrated in FIG. 7d, the light guard 100 is rotated so that the opening 50 in the first holder part 30 through which the reflectance standard 80 was inserted is now closed by the light guard 100. The performance of the spectrometric system, including its probe 6, may now be analysed.

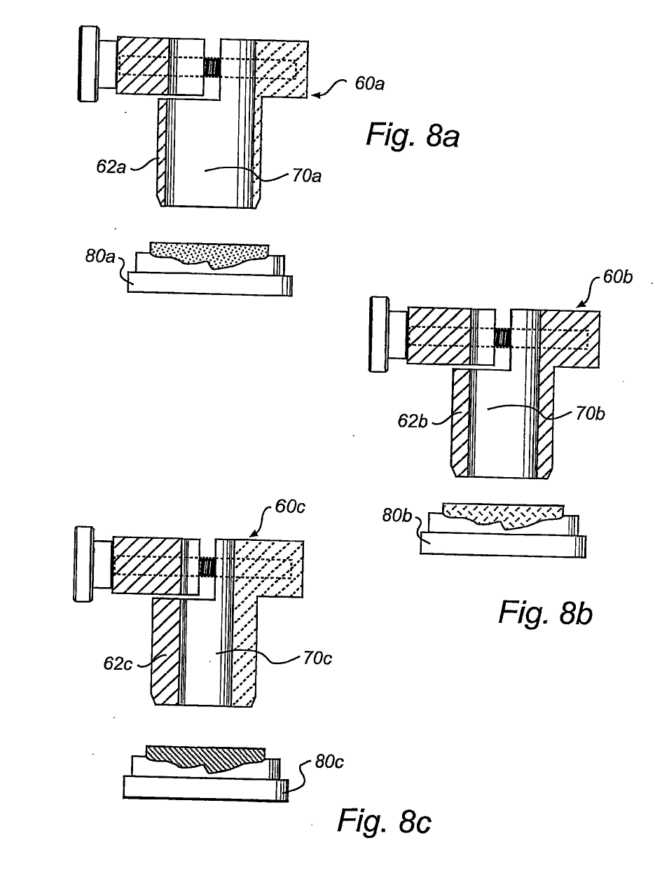

FIGS. 8a, 8b and 8c illustrate schematically components of a kit according to one embodiment of the invention The kit comprises three differently configured second holder parts 60a, 60b, 60c, the channel 70a, 70b, 70c of each holder part 60a, 60b, 60c having another cross-sectional dimension than the other two holder part channels. Thus, each one of said second holder parts 60a, 60b, 60c, are dimensioned to conform to a respective probe size. While the channel diameter is different between the second holder parts, the outer diameter of the protruding portion 62a, 62b, 62c of each one of said second holder parts 60a, 60b, 60c is the same. This means that each one may be fitted into the same first holder part Thus, while a first holder part holds one and the same reflectance standard, differently sized probes (e.g. 15 mm, 22 mm and 30 mm in diameter) may be connected to a respective second holder part 60a, 60b, 60c for transmitting electromagnetic radiation to and from that reflectance standard. Naturally, it is possible to change reflectance standards held by the first holder part, which in FIGS. 8a-8c is illustrated by three reflectance standards 80a, 80b, 80c, each one having a reflectance (e.g. between 1% and 99% reflectance, like different parts of a grey scale) which is different from the other two. It should be noted that any one of said three second holder parts 60a, 60b, 60c in the kit may be used with a first holder part carrying any one of said three reflectance standards 80a, 80b, 80c in the kit. It should also be noted that the kit may comprise another number of second holder parts and reflectance standards than what is illustrated in FIGS. 8a-8c.

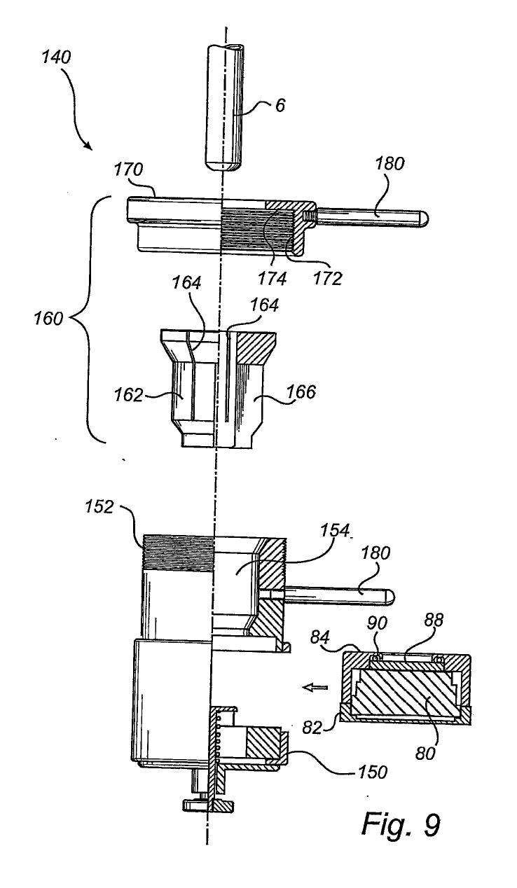

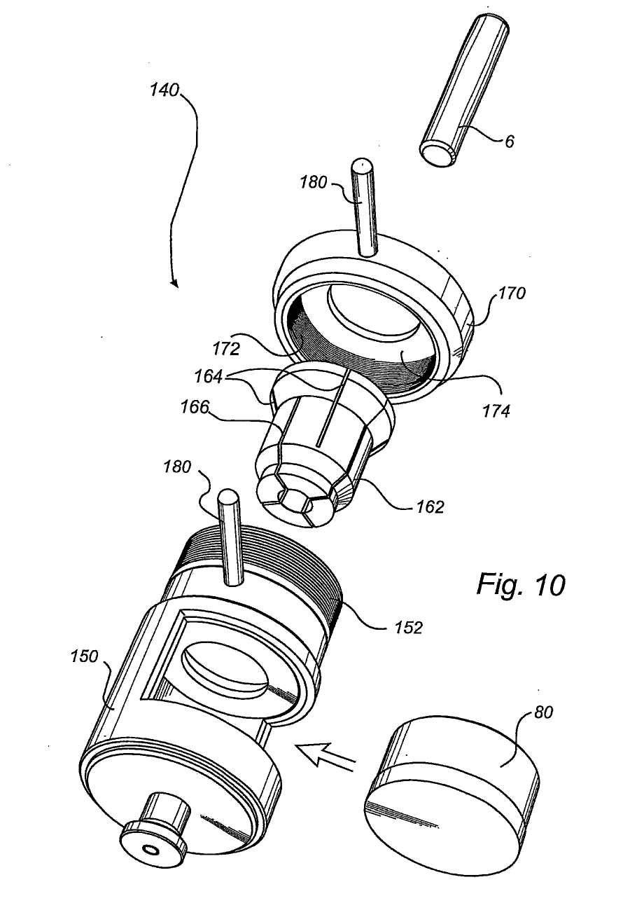

FIGS. 9 and 10 illustrate an assembly comprising a reflectance standard 80 and a device 140 according to another embodiment of the invention. The device comprises a first holder part 150 for holding the reflectance standard 80 and a second holder part 160 for holding the probe 6.

The first holder part 150 of this embodiment has features that substantially correspond to those of the first holder part 30 of the embodiment shown in FIGS. 3 and 4. However, at a proximal portion of the enveloping surface, the first holder part 150 is provided with external threads 152. Also, the inner diameter of the proximal cavity portion 154 of the first holder part 150 is designed to conform with the outer shape of an adjustable collet 162 of the second holder part 160, and does therefore have a slightly different shape than the proximal cavity portion 32 of the embodiment shown in FIGS. 3 and 4.

The second holder part 160 comprises the adjustable collet 162 and a collet nut 170 adapted to be passed over the collet 162 for tightening the collet 162 around the probe 6. The collet 162 is suitably made of a flexible material, such as a plastic material, and the collet nut 170 is suitably made of a more rigid material, such as a metal. In the illustrated embodiment, the collet 162 has a generally circular cross-section, the diameter being different at different sections of the collet 162 (smallest at the distal end and largest at the proximal end. The collet 162 is provided with four elongate proximal slits 164, spaced from each other along the circumference of the collet 162 at about 900. These proximal slits 164 extend from the proximal end of the collet 162 about three quarters of the length of the collet, terminating before the distal end of the collet 162. There are also provided four elongate distal slits 166, the distal slits 166 being spaced from the proximal slits 164 at approximately 45° along the circumference of the collet 162, and from each other at is about 90°. These distal slits 166 extend from the distal end of the collet 162 about three quarters of the length of the collet 162, terminating before the proximal end of the collet 162. The proximal slits 164 and the distal slits 166 allow for deformation of the collet 162 when pressure is applied upon the collet 162 so that a probe 6 held therein may be fixated. The pressure is applied by means of the collet nut 170. The collet nut 170 is provided with internal threads 172 having a diameter and pitch corresponding to the external threads 152 on the first holder part 150. The proximal end of the collet nut 170 has a ring-shaped cross-section allowing the probe 6 to be displaced through the ring 172. The ring has a portion 174 which will come into contact with the collet 162 when the collet nut 170 is threaded upon the first holder part 150. The collet nut 170 will eventually come to apply a pressure on the collet 162 so that the collet 162 becomes deformed to clamp the probe 6. Both the collet nut 170 and the first holder part 150 are provided with a respective rod-shaped gripping means 180, the use of which facilitates for the user to tighten the collet nut 170.

The device 140 is suitably assembled by initially inserting the collet 162 into the proximal cavity portion 154 of the first holder part 150, a proximal portion of the collet 162 remaining outside the first holder part 150. Next the collet nut 170 is mounted and screwed onto the first holder part 150 along the matching threads 152 and 172, respectively. Before completely the collet nut 162 is completely tightened, the probe 6 is inserted through the collet nut 170 and into the collet 162, allowing the tip of the probe 6 to protrude distally from the collet 162. When the probe 6 has been inserted, the collet nut 170 is tightened to its end position, thereby exerting a force on the collet 162, which in turn will clamp the probe 6 and preventing it from becoming retracted. Suitably, the reflectance standard 80 is inserted into the device 140 after the device 140 has been assembled.

It should be noted that even though this embodiment described a specific collet 162 and collet nut 170, the invention does not exclude the use of other types of collets and collet nuts for fixating the probe. It should also be noted, that similarly to the kit shown in FIG. 8, the collet according to this embodiment may also come in different shapes and different channel sizes to fit differently sized probes.

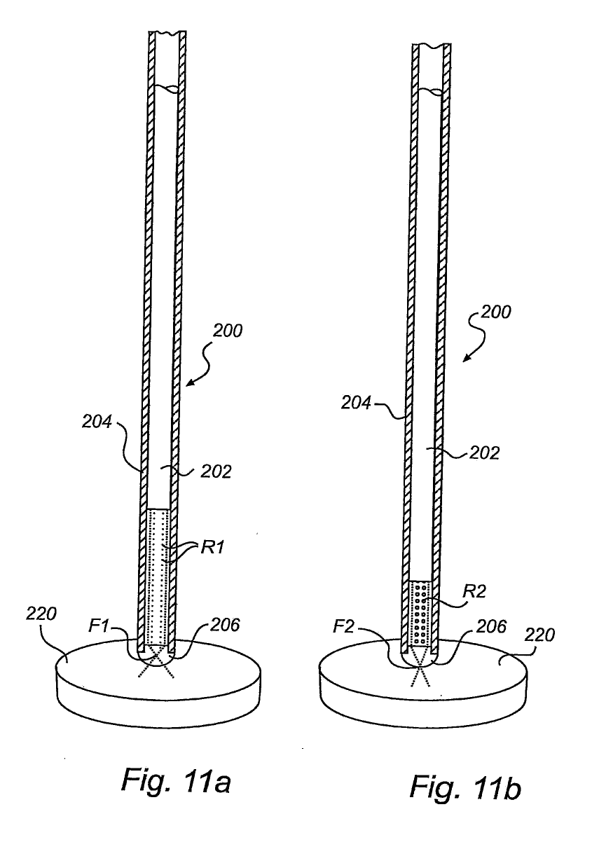

FIGS. 11a-11b illustrate schematically a method of positioning a bundle of fibres of a probe relative to a tip of the probe. The illustrated probe 200 has a bundle of fibres 202, wherein the outer fibres transmit output radiation from the probe and the central fibres transmit reflected input radiation back to the spectrometer. However, it should be understood that this is merely an example and that the principle of the method is applicable to other fibre configurations as well.

The schematic drawings of the probe 200 show that the probe 200 comprises a sleeve 204 which encloses the bundle of fibres 202. A tip 206, suitably of sapphire glass, is provided at the distal end of the sleeve 204. The probe tip 206 is positioned in contact with a reflectance standard 220, but may alternatively, as previously discussed, be in contact with a protective layer such as a sapphire glass window, or as another alternative at a non-zero distance from the reflectance standard 220. The reflectance standard 220 and the probe 200 may suitably be held by a device as previously described and illustrated in the previous drawings, however other alternative means for fixing the components are also conceivable. It should thus be understood that the principle of the method is applicable to several arrangements and that FIGS. 11a-11b merely illustrate a schematic example.

In FIG. 11a the distance between the bundle of fibres 202 and the tip 206 is such that the focus F1 of the output radiation is located before the radiation exits from the tip 206 for interaction with the reflectance standard 220. The diffusely reflected radiation R1 returning back down the core of the bundle of fibres 202 will be relatively weak.

In FIG. 11b the bundle of fibres 202 has been moved closer to the tip 206 so that the focus F2 of the output radiation is approximately at the interface between the tip 206 and the reflectance standard 220. In this position, the radiation R2 returning down the core of the bundle of fibres 202 to the spectrometer will be stronger, and will be observed as a higher signal (peak) in the spectrum obtained. Thus, when using the method, the operator may suitably select for the bundle of fibres 202 the position in which the highest signal is obtained.

1. A device for use in analysing the performance of a spectrometric system of the type which comprises a spectrometer to which a probe for propagating electromagnetic radiation is connected, the device comprising:
a holder dimensioned and configured for holding both
a reflectance standard which has a reflecting portion for receiving incident electromagnetic radiation and diffusely reflecting at least part of said radiation, and
the probe so that the tip of the probe is fixated at a predetermined position relative to the reflectance standard and so that at least part of the electromagnetic radiation emitted from the probe is diffusely reflected from the reflectance standard back to the probe.

2. The device as claimed in claim 1, wherein the holder comprises:
a first holder part for holding the reflectance standard, the first holder part having a proximal end and a distal end, and
a second holder part for holding the probe so that the tip of the probe is fixated at said predetermined position relative to the reflectance standard,
wherein said proximal end of the first holder part is facing said second holder part.

3. The device as claimed in claim 2, wherein said first holder part and said second holder part are releasably connectable to each other.

4. The device as claimed in claim 3, wherein said first holder part comprises first engagement means and said second holder part comprises second engagement means, wherein said first and second engagement means are engageable to each other for preventing, at least in one direction, relative movement between said first and second holder parts.

5. The device as claimed in claim 2, wherein said first holder part defines a proximal cavity portion which is dimensioned to receive a mating protruding portion of the second holder part.

6. The device as claimed in claim 5, wherein said second engagement means is in the form of a recess in the enveloping surface of the protruding portion of the second holder part, and said first engagement means is in the form of a pin-shaped member projecting from or through the wall of the first holder part.

7. The device as claimed in claim 5, wherein said first engagement means is in the form of an external thread on the enveloping surface of the first holder part, and said second engagement means is in the form of a nut having internal threads for cooperating with said external threads, wherein the nut is adapted to prevent said mating protruding portion of the second holder part to be retracted from said proximal cavity portion of the first holder part.

8. The device as claimed in claim 1, wherein the holder comprises:
a fixing means for arranging a first component at a fixed position in the holder, and
an actuator adapted to displace a second component towards said first component, wherein the first component is either one of the reflectance standard or the probe, and the second component is the other one of the reflectance standard or the probe.

9. The device as claimed in claim 8, wherein said fixing means is adapted to releasably fix the tip of the probe at a fixed position in the holder, the device comprising a space for receiving the reflectance standard, wherein said actuator comprises a spring means adapted to act on the reflectance standard when received in said space for displacing the reflectance standard toward the probe.

10. The device as claimed in claim 9, wherein the spring means comprises a rod assembly comprising:
a proximal end portion facing the reflectance standard,
a distal end portion, and
an intermediate rod portion which is displaceable through a hole at the distal end of the holder,
wherein a spring acts on the rod assembly so that the proximal end portion of the rod assembly, which is displaceable within the space, is enabled to displace the reflectance standard towards the probe.

11. The device as claimed in claim 1, further comprising a channel for guiding the probe, the channel having a proximal end through which the probe is introducible and a distal end through which the tip of the probe is protrudable for contacting the reflectance standard or a protective layer covering the surface of the reflectance standard.

12. The device as claimed in claim 11, wherein said channel is defined by an adjustable collar or collet which is adapted to be tightened around the probe for holding the tip of the probe in a fixed position.

13. The device as claimed in claim 12, further comprising a nut adapted to come into contact with the proximal end of the collar or collet for tightening it around the probe, wherein the nut comprises internal threads for cooperating with external threads on the enveloping surface of the first holder part.

14. The device as claimed in claim 1, further comprising a casing for enclosing the reflectance standard, wherein the holder is adapted to indirectly hold the reflectance standard by holding the casing.

15. The device as claimed in claim 14, wherein the casing is provided with:
an aperture which allows incident electromagnetic radiation to reach the reflectance standard, and
a protective window covering the reflectance standard, the protective window being transparent to the incident electromagnetic radiation.

16. The device as claimed in claim 15, wherein the aperture has a diameter which is large enough for enabling the tip of the probe to be introduced therethrough so as to come into contact with the protective window.

17. The device as claimed in claim 1, further comprising:
a housing which is provided with an opening for receiving and removing the reflectance standard, and
a light guard for reducing the amount of light entering the housing through said opening, wherein the light guard is movable between a covering position in which it at least partially covers said opening and an exposing position in which said opening is exposed for receiving or removing the reflectance standard.

18. A device as claimed in claim 1, wherein the reflectance standard is replaced by any reference material which has a reflecting portion for receiving incident electromagnetic radiation and diffusely reflecting at least part of said radiation.

19. An assembly for use in analysing the performance of a spectrometric system of the type which comprises a spectrometer to which a probe for propagating electromagnetic radiation is connected, the assembly comprising:
a device as claimed in claim 1, and
a reflectance standard adapted to be held by the device, the reflectance standard having a reflecting portion for receiving incident electromagnetic radiation from the probe and diffusely reflecting at least part of said radiation to the probe.

20-22. (canceled)

23. A kit for use in analysing the performance of a spectrometric system of the type which comprises a spectrometer to which a probe for propagating electromagnetic radiation is connected, the probe having one of a plurality of possible diameters, wherein the kit comprises:
a first holder part for holding a reflectance standard which has a reflecting portion for receiving incident electromagnetic radiation and diffusely reflecting at least part of said radiation,
a plurality of second holder parts, each one of said second holder parts being releasably connectable to the first holder part and adapted to hold a probe so that the tip of the probe is fixated at a predetermined position relative to the reflectance standard and so that at least part of the electromagnetic radiation emitted from the probe is diffusely reflected from the reflectance standard back to the probe,
wherein at least one of said second holder parts is adapted to hold a probe that has a different diameter than a probe which the rest of the second holder parts are adapted to hold.

24. The kit as claimed in claim 23, wherein each one of said second holder parts comprises a channel for guiding the probe, wherein the channel of at least one of said second holder has a different cross-sectional dimension than the respective channel of the rest of said second holder parts.

25. The kit as claimed in claim 23, comprising a plurality of reflectance standards, wherein at least one of said plurality of reflectance standards has a different reflectance than the rest of said plurality of reflectance standards.

26. (canceled)

27. A method for analysing the performance of a spectrometric system of the type which comprises a spectrometer to which a probe for propagating electromagnetic radiation is connected, the method comprising:
providing a reflectance standard which has a reflecting portion for receiving incident electromagnetic radiation and diffusely reflecting at least part of said radiation,
fixating the tip of the probe at a predetermined position relative to the reflectance standard so that at least part of the electromagnetic radiation emitted from the probe is diffusely reflected from the reflectance standard back to the probe,
emitting an electromagnetic radiation from the spectrometer via the probe to the reflectance standard, and
analysing the electromagnetic radiation which is diffusely reflected back to the spectrometer via the probe.

28-30. (canceled)

31. A device for analysing the performance of a spectrometric system of the type which comprises a spectrometer to which a probe for propagating electromagnetic radiation is connected, the device comprising:
a probe holder for holding the probe, and
a movable support for supporting a reflectance standard unit, the reflectance standard unit comprising a reflectance standard having a reflecting portion for receiving incident electromagnetic radiation from the probe and diffusely reflecting at least part of said radiation back to the probe, wherein the support is movable towards the probe for making the reflectance standard unit come into contact with the tip of the probe.

32-34. (canceled)

35. A method for analysing the performance of a spectrometric system of the type which comprises a spectrometer to which a probe for propagating electromagnetic radiation is connected, the method comprising:
holding the probe, the tip of the probe pointing along a geometrical axis,
providing a reflectance standard which has a reflecting portion for receiving incident electromagnetic radiation and diffusely reflecting at least part of said radiation,
arranging the reflectance standard on said geometrical axis in front of the tip of the probe,
displacing the reflectance standard along said geometrical axis so that it, or a protective layer that covers and follows any motion of the reflectance standard, comes into contact with the probe,
emitting an electromagnetic radiation from the spectrometer via the probe to the reflectance standard, and
analysing the electromagnetic radiation which is diffusely reflected back to the spectrometer via the probe.

36. A method of positioning a bundle of fibres of a probe relative to a tip of the probe, said probe being connected to a spectrometer and being adapted to propagate electromagnetic radiation through the fibres, the method comprising:
providing a reflectance standard which has a reflecting portion for receiving incident electromagnetic radiation and diffusely reflecting at least part of said radiation,
fixating the tip of the probe at a predetermined position relative to the reflectance standard so that at least part of the electromagnetic radiation emitted from the probe is diffusely reflected from the reflectance standard back to the probe,
emitting an electromagnetic radiation from the spectrometer via the probe to the reflectance standard,
moving the bundle of fibres relative to the tip of the probe to different positions, and
determining in which of the positions the bundle of fibres propagates the highest amount of electromagnetic radiation, which has been diffusely reflected, back to the spectrometer.

37. (canceled)

38. (canceled)

39. The method as claimed in claim 35, wherein the protective layer is a sapphire glass window.
